(19) United States
(12) Patent Application Publication
(10) Pub. No.: US 2026/0288638 A1
(43) Pub. Date: Sep. 24, 2026

(54) SYSTEMS AND METHODS FOR CACHE MANAGEMENT USING MULTIPLE MAPS AND A VALID MAP INDICATOR

(71) Applicant: SICILY MERGER SUB II, INC., Santa Clara, CA (US)

(72) Inventors: Martinus Bos, Santa Jose, CA (US); Daniel Cohen, Santa Clara, CA (US); Trung Diep, San Jose, CA (US); Philip Winterbottom, San Jose, CA (US)

(73) Assignee: SICILY MERGER SUB II, INC., Santa Clara, CA (US)

(21) Appl. No.: 19/083,921

(22) Filed: Mar. 19, 2025

(51) Int. Cl. G06F 12/0802

(52) U.S. Cl. CPC G06F 12/0802

(57) ABSTRACT

A register may store a valid map indicator, a cache memory may store a plurality of cache entries, and a cache management circuit may perform a caching operation in response to receiving a memory access request that includes an address. The caching operation may include using a specific map to map the address to a cache entry in the cache memory in response to determining that the valid map indicator indicates the specific map. The cache management circuit my respond to the memory access request by returning data from the cache entry in response to determining that the cache entry includes a map indicator that equals the valid map indicator.

### TECHNICAL FIELD

The systems and methods relate to computer systems that include cache memory, caching, mapping between cache entries and memory blocks, and to optimizing cache memory utilization by selecting an effective mapping between cache entries and memory. The systems and methods also relate to storing a valid map indicator that indicates which one of a plurality of maps is currently being used for mapping between cache entries and memory.

### BACKGROUND

Demands for memory in artificial intelligence (AI) computing, such as machine learning (ML) and deep learning (DL), are increasing faster than they can be met by increases in available capacity offerings. This rising demand and the growing complexity of AI models drive the need to cache large volumes of data between compute and/or memory nodes in a data center. In many conventional distributed systems, data movement leads to significant power consumption, poor performance, and excessive latency. Thus, multi-node computing systems that can efficiently cache data for the compute nodes may be advantageous for the implementation of AI computing.

### BRIEF DESCRIPTION OF THE DRAWINGS

FIG. 1A is a perspective view of an example of a circuit package that includes an electronic integrated circuit (EIC) that is stacked on a photonic integrated circuit (PIC) to produce a multiport network switch, according to some aspects.

FIG. 1B is a side view of the circuit package from FIG. 1A that includes the EIC and the PIC, and in which the PIC is mounted on a substrate, according to some aspects.

FIG. 2A is a side view of an example photonic transceiver of a multiport network switch relative to an EIC and a PIC in which a portion of the photonic transceiver is embodied in the EIC and a portion of the photonic transceiver is embodied in the PIC.

FIG. 2B is an expanded side view of the photonic transceiver from FIG. 2A.

FIG. 2C shows a view of the bottom major surface of the EIC, including the driver interface and the amplifier interface exposed at the bottom major surface of the EIC.

FIG. 3 depicts an example of a memory module that includes an EIC stacked on a PIC, a first memory unit, and a second memory unit, in which at least one photonic transceiver is formed between the EIC and the PIC.

FIG. 4 is an expanded view of an example of the cache manager from FIG. 3.

FIG. 5 is a high level conceptual diagram illustrating an example of a cache management circuit configured to use a valid map indicator, according to some aspects.

FIG. 6 is a high level flow diagram illustrating an example of a process that uses a cache memory for reading data corresponding to a memory address, according to some aspects.

FIG. 7 is a high level flow diagram illustrating an example of a process that uses a cache memory for writing data corresponding to a memory address, according to some aspects.

FIG. 8 is a high level conceptual diagram illustrating an example of a cache management circuit configured to change the valid map indicator to indicate a second map, according to some aspects.

FIG. 9 is a high level conceptual diagram illustrating an example of a cache management circuit configured to increment counters, according to some aspects.

FIG. 10 is a high level conceptual diagram illustrating an example of a mapping circuit, according to some aspects.

FIG. 11 is a high level conceptual diagram illustrating an example of a plurality of mapping circuits, according to some aspects.

FIG. 12 is a high level flow diagram illustrating an example of a process that selects a best map, according to some aspects.

FIG. 13 is a high level flow diagram illustrating an example of a process that marks cache entries invalid, according to some aspects.

FIG. 14 is a high level flow diagram illustrating an example of a method for cache management using multiple maps and a valid map indicator, according to some aspects.

Throughout the description, similar reference numbers may be used to identify similar elements.

### DETAILED DESCRIPTION

It will be readily understood that the components of the examples as generally described herein and illustrated in the appended figures could be arranged and designed in a wide variety of different configurations. Thus, the following more detailed description of various examples, as represented in the figures, is not intended to limit the scope of the present disclosure, but is merely representative of various examples. While the various aspects of the examples are presented in drawings, the drawings are not necessarily drawn to scale unless specifically indicated.

The claimed aspects may be embodied in other specific forms without departing from its spirit or essential characteristics. The examples described are to be considered in all respects only as illustrative and not restrictive. The scope of the claims is, therefore, indicated by the appended claims themselves rather than by this detailed description. All changes which come within the meaning and range of equivalency of the claims are to be embraced within their scope.

Reference throughout this specification to features, advantages, or similar language does not imply that all the features and advantages that may be realized should be realized or are realized in any single example. Rather, language referring to the features and advantages is understood to mean that a specific feature, advantage, or characteristic described in connection with an example is included in at least one example. Thus, discussions of the features and advantages, and similar language, throughout this specification may, but do not necessarily, refer to the same example.

Furthermore, the described features, advantages, and characteristics may be combined in any suitable manner in one or more examples. One skilled in the relevant art will recognize, in light of the description herein, that the claimed aspects may be practiced without one or more of the specific features or advantages of a particular example. In other instances, additional features and advantages may be recognized in certain examples that may not be present in all examples.

Reference throughout this specification to “one example”, “an example”, or similar language means that a particular feature, structure, or characteristic described in connection with the indicated example is included in at least one example. Thus, the phrases “in one example”, “in an example”, and similar language throughout this specification may, but do not necessarily, all refer to the same example.

AI workloads are memory intensive and often require huge caches in the memory system. For example, OpenAI's GPT-4 model is an example believed to have approximately 1.8 trillion parameters across multiple models and components. 1.8 trillion parameters would require approximately 3.6 TB of memory, assuming a 16 bit floating point format such as FP 16. Given the massive size of current AI models the models are typically spread out across numerous compute nodes and the parameters needed by each compute node are cached near that compute node. As such, multi gigabyte cache memories may be required. In an example, the AI model may be stored in double data rate (DDR) synchronous dynamic random-access memory (SDRAM) and may be cached in high bandwidth memory (HBM). The cache may be, for example, 32 GB of HBM. An issue with using extremely large cache memories is the time required for initializing or reinitializing the cache. For example, every cache entry may include a valid bit that is set to zero on initialization of the cache and on reinitialization of the cache. Such an operation may take seconds when the cache is extremely large. Reinitializing the cache is thereby discouraged.

One aspect of using a cache memory effectively is selecting a map that maps memory addresses to cache entries. Direct caching is typically used for AI models. As is known in the art, direct caching may use a specific set of bits in a memory address to select a cache entry in the cache memory. This is called the map. In an example, the cache has 32 entries and the most significant 5 bits of an address are used to select one of the cache entries (e.g., “00101” is mapped to cache entry 5). In another example, the cache has 64 entries and the most significant 6 bits of an address may be used to select one of the cache entries (e.g., “000101” is mapped to cache entry 5). In yet another example, the cache has 64 entries and the second most significant through the seventh most significant bits of an address may be used to select one of the cache entries (e.g., the most significant bits “0000101” and “1000101” are mapped to cache entry 5).

An issue that has become important in the management of large caches such as a 32 GB HBM cache is the ability to efficiently change the map between memory address and cache entry. Different workloads run more efficiently with different maps. In fact, some workloads may have changing memory access patterns that would be better served by different maps. However, changing the map could require marking every cache entry as invalid or reinitializing the cache. Reinitializing a cache may include marking every cache entry as invalid. A cache entry may be marked invalid by changing a valid flag (e.g., a bit where 0 indicates invalid and a 1 indicates valid). Clearing a bit in billions of cache entries may easily exceed a few seconds, which is unacceptable in many environments.

An alternative is to maintain a valid map indicator that indicates what map is currently being used for mapping memory addresses to cache entries. Each cache entry includes a map indicator that may be compared to the valid map indicator to detect when the map used for the cache entry has become invalid. As such, the map that maps memory addresses to cache entries may be changed by simply changing the valid map indicator. Changing the valid map indicator may effectively invalidate every cache entry without requiring reinitialization or changing the valid flags in the cache entries. Changing the valid map indicator may be thought of as an infinitely fast cache flush. This allows for dynamically changing the map without interrupting the workload using the map. In fact, the best map for a workload may be identified by testing several different maps while the workload is running. A further advantage is that a map for a workload may be selected when the workload is started. The map that is selected may be chosen by a data center customer such as an LLM service provider that knows which map works best on what hardware. The map that is selected may be chosen by a data center operator via testing, perhaps as a service for data center customers. Another advantage is that the maps may be regularly tested (e.g., triggered by a timer, a service technician, and AI agent, etc.) to select the currently best map in an automated manner.

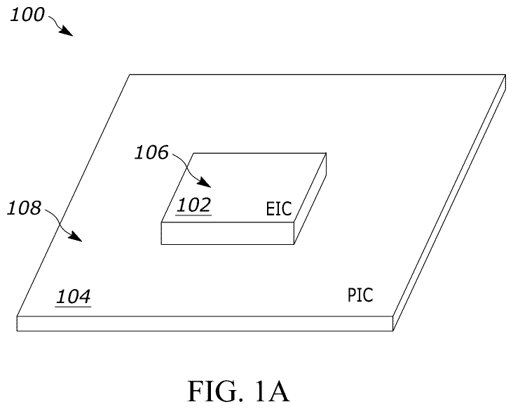

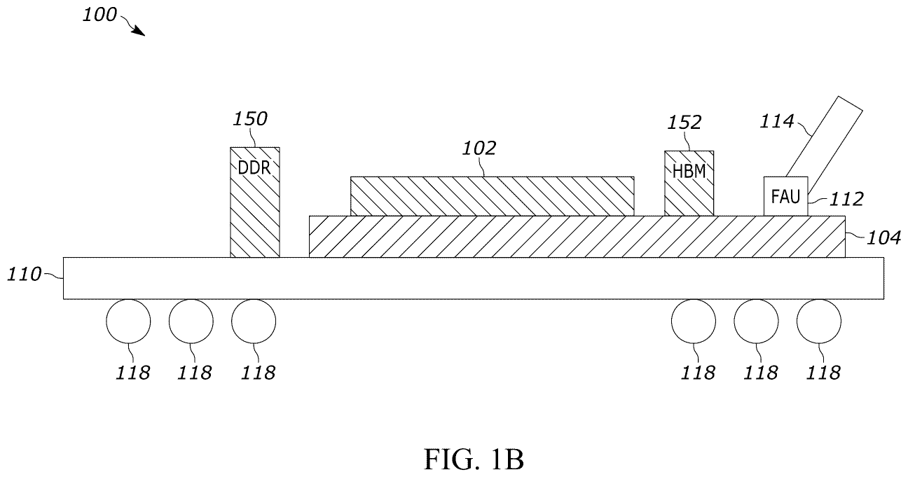

FIGS. 1A, 1B, 2A, 2B, 2C, 3, and 4 are presented as nonlimiting examples of a system that may implement multiple maps, a valid map indicator, and cache entries that each include map indicators.

FIG. 1A is a perspective view of an example of a circuit package 100 that includes an electronic integrated circuit (EIC) that is stacked on a photonic integrated circuit (PIC) to produce a multiport network switch, according to some aspects. The circuit package 100 includes an EIC 102 that is stacked on a PIC 104 to produce a memory module that includes multiple photonic transceivers (not shown). In the example, both the EIC and the PIC are planar structures that have two major surfaces, referred to herein as a top major surface and a bottom major surface. In the perspective view of FIG. 1A, the top major surfaces 106 and 108 of both the EIC and the PIC are visible and the bottom major surface of the EIC is directly adjacent to, and parallel to the plane of, the top major surface of the PIC. It should be noted that the EIC and the PIC are not to scale and their sizes relative to each other may be different from that which is shown in FIG. 1A. Additionally, the PIC may be attached to a planar substrate that includes electrical connections to the PIC and to the EIC. In an example, the EIC and PIC are physically and electrically connected to each other by electrical interconnects, e.g., solder bumps, and the distance between the bottom major surface of the EIC and the top major surface of the PIC is less than 2 mm and, in many cases, less than 50 microns.

FIG. 1B is a side view of the circuit package 100 from FIG. 1A that includes the EIC 102 and the PIC 104, and in which the PIC is mounted on a substrate 110, according to some aspects. FIG. 1B also depicts a first memory unit 150 (e.g., DDR SDRAM), a second memory unit 152 (e.g., HBM), optical elements, including an external optical interface 112 such as fiber array unit (FAU) on the PIC and external waveguides 114 (e.g., optical fibers) connected to the FAUs. Again, it should be noted that the elements depicted in FIG. 1B may not be to scale. In the example of FIGS. 1A and 1B, the EIC and the PIC are formed in separate semiconductor chips, typically silicon chips, although the use of other semiconductor materials is possible. In the example of FIG. 1B, the PIC is attached directly to the substrate and the substrate includes solder bumps 118 for subsequent mounting to, for example, a printed circuit board (PCB). In the example of FIG. 1B, the FAU that connects the PIC to the external waveguides (e.g., optical fibers) is positioned on top of and optically connected to the PIC although other means of connecting optical waveguides to the PIC are possible. Optionally, the circuit package 100 shown in FIGS. 1A and 1B may further include other elements that are attached onto the PIC.

In the example of FIG. 1B, the first memory unit 150 is DDR memory and the second memory unit 152 is HBM memory although other types of memory are possible. In the example of FIG. 1B, the first memory unit (e.g., DDR SDRAM) is physically attached directly to the substrate 110 and the second memory unit (e.g., HBM) is physically attached directly to the PIC 104. The first and second memory units are described in more detail below.

In an example, an FAU is a device used in optical communication systems that combines or separates optical signals from multiple fibers into a single optical signal or multiple optical signals, respectively. The FAU can be used for a variety of applications, such as wavelength division multiplexing (WDM), parallel optical interconnects, and optical sensing. There are two main types of fiber array units that can be used: linear and circular. Linear FAUs combine or separate optical signals along a straight line, while circular fiber array units combine or separate optical signals in a circular configuration. Both types of FAUs are typically made from a precision-molded optical plastic or ceramic material and can have anywhere from a few to hundreds of fibers arranged in a specific pattern. The choice of FAU depends on the specific requirements of an application, such as the number of fibers, the arrangement of the fibers, the wavelength of light being used, and the coupling efficiency desired.

In an example, the EIC 102 includes high-speed integrated circuits configured to support the management of data between the first and second memory units 150 and 152, respectively, and the photonic transceivers. The EIC may be an application specific integrated circuit (ASIC), a field programmable gate array (FPGA), or a System on Chip (SoC) that is designed and fabricated using state of the art CMOS nodes. The EIC may include circuits for serialization/deserialization, clock and data recovery, modulator drivers, and amplifiers that implement the photonic transceivers and circuits that implement the switching circuitry.

A waveguide may be a structure that guides and/or confines light waves to facilitate the propagation of the light along a desired path and to a desired location. For example, a waveguide may be an optical fiber, a planar waveguide, a glass-etched waveguide, a photonic crystal waveguide, a free-space waveguide, any other suitable structure for directing optical signals, and combinations thereof. In some examples, one or more internal waveguides are formed in the PIC 104. In some examples, one or more external waveguides are implemented external to the PIC, such as the optical fibers 114 or a ribbon comprising multiple optical fibers.

The PIC 104 may include one or more internal waveguides that are optically coupled to the external optical interface 112 of the memory module. For example, as will be discussed below in more detail, one or more of the optical interfaces may be optically coupled to another optical port on another computing device. In some examples, an internal waveguide of the PIC is implemented (e.g., formed) in the PIC to connect photonic elements internally within the PIC. In another example, one or more external optical interfaces of the PIC may be optically coupled to an optical interface of another computing device located in a separate circuit package or separate chip to form inter-chip connections. In some examples, an external waveguide is implemented in connection with the PIC to thereby connect photonic interfaces across multiple chips. For example, the external optical interfaces of the PIC may be connected via optical fibers across multiple chips. In some examples, an external waveguide (e.g., optical fiber) connects directly to photonic ports of respective computing devices across multiple chips. In some examples, an external waveguide is implemented in connection with one or more internal waveguides formed in the PIC of one or more of the chips. For example, one or more internal waveguides may internally connect one or more of the photonic ports to one or more additional optical components located at another portion of the circuit package (e.g., another portion of the PIC) to facilitate coupling with the external waveguides. For example, the internal waveguides within the PIC may connect to one or more optical coupling structures including FAUs located over grating couplers (GCs), or edge couplers. In some examples, one or more FAUs are implemented to facilitate coupling the external waveguides to the internal waveguides of the PIC to facilitate chip-to-chip interconnection to another circuit package to both transmit and receive optical signals. In some examples, one or more FAUs are implemented to supply optical power from an external laser light source to the PIC to drive the photonics (e.g., provide one or more optical carrier signals) in the PIC.

In an example, the EIC 102 and the PIC 104 may be manufactured using standard wafer fabrication processes, including, e.g., photolithographic patterning, etching, ion implantation, etc. Further, in some examples, heterogeneous material platforms and integration processes are used. For example, various active photonic components, such as laser light sources and optical modulators and/or photodetectors used in the photonic transceivers, may be implemented using group III-V semiconductor components.

As will be appreciated by those of ordinary skill in the art, the depicted structure of the circuit package 100 is merely one of several possible ways to assemble and package the various components. In some examples, some or all of the EIC 102 is disposed on the substrate 110. In some examples, it is also possible to create the EIC and the PIC 104 in different layers of a single semiconductor chip. In some examples, the photonic circuit layer includes or is made of multiple PICs. Multiple layers of PICs, or a multi-layer PIC may help to reduce waveguide crossings. Moreover, the structure depicted in FIGS. 1A and 1B may be modified to include multiple EICs connected to a single PIC. For example, multiple EICs may be connected to each other via photonic channels in the PIC. Additionally, although the DDR 150 is attached to the substrate and the HBM 152 is attached to the PIC, other configurations are possible, including both the DDR and the HBM being attached to the PIC.

In an example, a light source, or light sources, is/are optically coupled to the circuit package 100, e.g., a memory module. The light source or light sources may include laser light sources that are implemented either in the circuit package or externally. When implemented externally, a connection to the circuit package may be made optically using a grating coupler in the PIC 104 underneath the FAU 112 and/or using an edge coupler. In some examples, lasers are implemented in the circuit package by using an interposer containing several lasers that can be co-packaged and edge-coupled with the PIC. In some examples, the lasers are integrated directly into the PIC using heterogenous or homogenous integration. Homogenous integration allows lasers to be directly implemented in the silicon substrate in which the waveguides of the PIC are formed, and allows for lasers of different materials, such as indium phosphide (InP), and architectures such as quantum dot lasers. Heterogenous assembly of lasers on the PIC allows for group III-V semiconductors or other materials to be precision-attached onto the PIC and optically coupled to a waveguide implemented on the PIC.

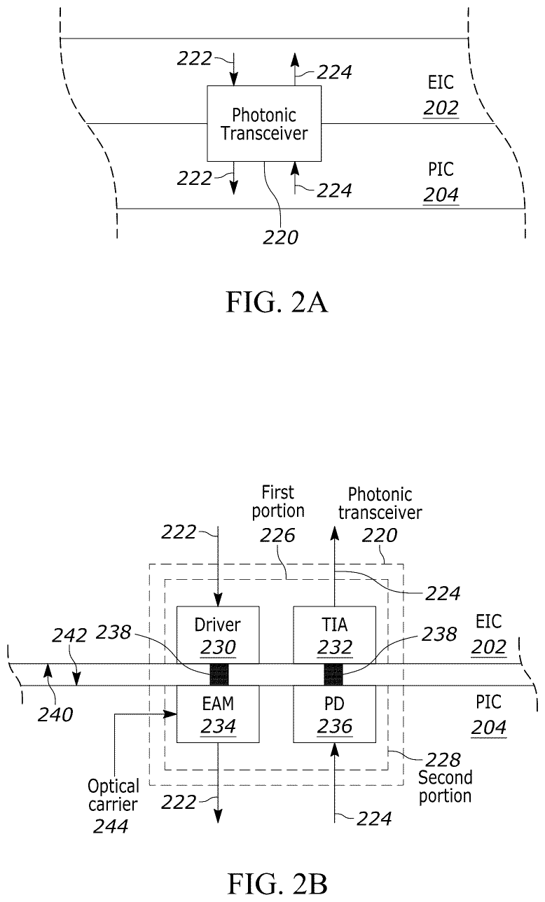

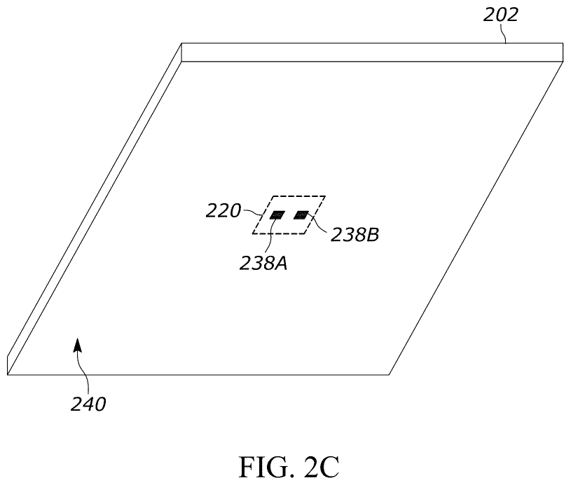

In an example, data is communicated between the EIC 102 and the PIC 104 using photonic transceivers in which each photonic transceiver includes a first portion in the EIC and a second portion in the PIC. FIG. 2A is a side view of an example photonic transceiver 220 of a memory module relative to an EIC 202 and a PIC 204 in which a portion of the photonic transceiver is embodied in the EIC and a portion of the photonic transceiver is embodied in the PIC. Although not shown in FIG. 2A, in an example memory module, the photonic transceiver is optically coupled to an external optical interface of the PIC and electrically coupled to switching circuitry of the EIC. As indicated by the arrows and as is described further below, digital data can be passed from the electrical domain of the EIC to the optical domain of the PIC (arrows 222) and digital data can be passed from the optical domain of the PIC to the electrical domain of the PIC (arrows 224). Examples of how the photonic transceivers are used to form a memory module are described below.

FIG. 2B is an expanded side view of the photonic transceiver 220 from FIG. 2A in which a first portion 226 of the photonic transceiver in the EIC 202 includes a driver 230 and an amplifier 232 (e.g., a transimpedance amplifier (TIA)) and a second portion 228 of the photonic transceiver in the PIC 204 includes a modulator 234 (e.g., an Electro-Absorption Modulator (EAM)) and a photodetector 236. The first portion of the photonic transceiver and the second portion of the photonic transceiver are electrically connected to each other by electrical interconnects 238. In an example, the first portion and the second portion of a photonic transceiver are vertically aligned with each other such that components of the first portion and the second portion overlap with each other or are very close to each other when viewed from a plan view. In an example, the electrical interconnects are copper pillars no longer than 2 millimeters and in many cases less than 200 microns and in other cases less than 50 microns. In other examples, the electrical interconnects can be solder bumps that are formed of a material such as tin, silver, copper, alloys thereof, etc. If solder bumps are used for the electrical interconnects, then the solder bumps may be flip-chip bumps. In yet another example, the interconnects may be elements of a ball-grid array (BGA), pins of a pin grid array (PGA), elements of a land grid array (LGA), or some other type of electrical interconnect. Generally, the electrical interconnects may physically and electrically couple the portion of a photonic transceiver that is in the EIC to the portion of the photonic transceiver that is in the PIC. For example, one or more of the electrical interconnects may physically couple with, and allow electrical signals to pass between, conductive pads of the EIC and conductive pads of the PIC. The electrical interconnects may not have a uniform size, shape, or pitch. A finer pitch of interconnects may be desirable to allow a denser communication pathway between elements coupled to the PIC. In some implementations, the size, shape, pitch, or type of one or more of the electrical interconnects may be different from those depicted in the figures, or different from other types of electrical interconnects. The specific type, size, shape, or pitch of the electrical interconnects may be based on one or more factors such as use case, materials used, design considerations, and manufacturing considerations.

In an example, the driver 230 and the amplifier 232 of the first portion 226 of the photonic transceiver 220 include electronic circuits that are fabricated in the EIC 202. In an example, the first portion of the photonic transceiver is an analog/mixed signal (AMS) block that includes circuits for processing analog signals or circuits for processing analog signals and circuits for processing digital signals. The driver of the first portion of the photonic transceiver may include digital control and analog amplifier circuits. In an example, the driver includes a driver interface (not shown) that is exposed at the bottom major surface 240 of the EIC. The amplifier of the first portion of the photonic transceiver may include a transimpedance amplifier (TIA). In an example, the amplifier includes an amplifier interface (not shown) that is also exposed at the bottom major surface of the EIC. In an example, the driver interface and the amplifier interface include one or more conductive contacts or pads that are electrically coupled to electronic circuits of the respective components and that are exposed at the bottom major surface of the EIC. FIG. 2C shows a view of the bottom major surface 240 of the EIC 202, including the driver interface 238A and the amplifier interface 238B exposed at the bottom major surface of the EIC. It should be understood that the EIC may include multiple photonic interfaces with corresponding driver and amplifier interfaces exposed at the bottom major surface. In an example, the driver interface and/or the amplifier interface of the EIC is slightly offset from the corresponding interconnect such that the interface does not sit directly on top of the corresponding interconnect in order to avoid parasitic capacitance.

The modulator 234 of the second portion 228 of the photonic transceiver 220 may include an Electro-Absorption Modulator (EAM) that is fabricated into the PIC 204, for example, the EAM may be a Germanium-Silicon (GeSi) EAM. Other examples of optical modulators include, but are not limited to, micro-ring resonators (MRRs), or any suitable optical component with sufficient thermal stability over the operating ranges of the photonic transceivers. In an example, the modulator has thermal stability over the operating range, may utilize the franz-keldysh effect, may utilize a quantum confined stark effect, and/or may utilize an external thermal control to increase thermal stability. In an example, the modulator includes a modulator interface (not shown) that is exposed at the top major surface 242 of the PIC. For example, the modulator interface may include one or more conductive contacts or pads that are electrically coupled to the modulator and that are exposed at the top major surface of the PIC.

The photodetector 236 of the second portion 228 of the photonic transceiver 220 includes electronic circuits that are fabricated into the PIC 204, for example, the photodetector may be a GeSi photodetector. In an example, the photodetector includes a photodiode and a photodetector interface (not shown) that are fabricated into the PIC. For example, the photodetector interface may include one or more conductive contacts that are exposed at the top major surface of the PIC.

FIG. 2B also illustrates the passing of data from the electrical domain of the EIC 202 to the optical domain of the PIC 204 (e.g., via the arrows 222 pointing “down” into the driver 230 and out from the modulator 234) and the passing of data from the optical domain of the PIC to the electrical domain of the EIC (e.g., via the arrows 224 pointing “up” into the photodetector 236 and out from the amplifier 232). With reference to the left side of FIG. 2B, in an example operation, signals representative of digital data are applied to the driver in the EIC, which cause the driver to generate signals that are passed through the interconnect 238 and drive the modulator in the PIC. In an example, an optical carrier 244 is modulated by the modulator in response to the signals from the driver and the modulated optical carrier propagates within an optical waveguide (not shown) of the PIC. Thus, the left side of FIG. 2B illustrates the transformation of signals from the electrical domain to the optical domain between the stacked EIC and PIC. With reference to the right side of FIG. 2B, a modulated optical carrier is received at the photodetector via an optical waveguide (not shown) of the PIC. The photodetector converts the modulated optical carrier into electrical signals that are passed via the interconnect to the amplifier of the EIC. The amplifier of the EIC amplifies the electrical signals and provides the amplified electrical signals to another component of the EIC, such as to an analog-to-digital converter (ADC) of the EIC. Thus, the right side of FIG. 2B illustrates the transformation of signals from the optical domain to the electrical domain between the stacked EIC and PIC.

HBM has been widely adopted to support the memory needs of GPUs for AI workloads. While HBM can provide fast access to data, HBM is generally more expensive than other types of memory such as DDR. Regardless of the type of memory employed, the stored data must still be accessed by a GPU. Placing the memory physically close to the GPU has a benefit of power efficiency but a drawback of limited physical space around the GPU, while placing the memory further away from the GPU has the benefit of more physical space for the memory but a drawback of increased power consumption due to longer transmission distances. It has been realized that photonic transceivers formed by an EIC stacked on an PIC as described with reference to FIGS. 2A and 2B can be coupled with memory interfaces and memory management logic (e.g., a memory controller and a cache manager) in the EIC and co-packaged with high capacity memory (e.g., DDR) and high speed memory (e.g., HBM) to form a memory module that can store large amounts of data while providing fast access to the data by a GPU over an optical channel in an extremely energy efficient manner, which enables the memory module to be located farther away from the GPU with a negligible increase in power consumption.

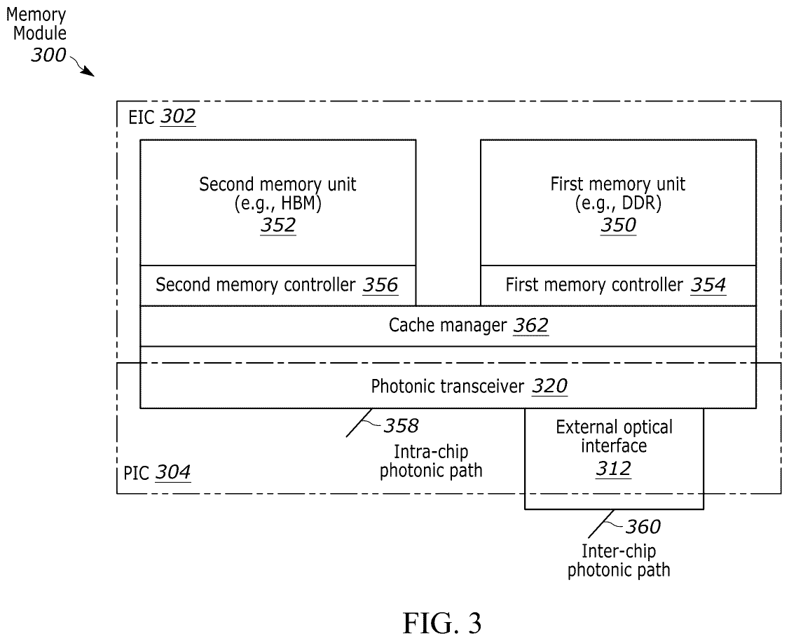

Referring to FIG. 3, in an example, a memory module 300 is shown that includes an EIC 302 stacked on a PIC 304 in which at least one photonic transceiver 320 is formed between the EIC 302 and the PIC 304 as described above with reference to FIGS. 2A and 2B. The memory module 300 includes an intra chip photonic path 358 and an external optical interface 312 that is connectable to an inter chip photonic path 360. Although the memory module is described as having an intra chip photonic path 358 and an inter chip photonic path 360, the memory module may have either an intra chip photonic path or an inter chip photonic path, or some combination of multiple intra and/or inter chip photonic paths. Additionally, the photonic paths may include multiple unidirectional photonic paths. For example, the photonic paths 358 and 360 may each include a unidirectional photonic path for data that is transmitted from the memory module and a unidirectional photonic path for data that is received at the memory module. The memory module also includes a first memory unit 350 that has an electrical connection to a second memory unit 352. The memory units can be memory units in the EIC 302, for example, with a variety of potential designs capable of implementing an electrical interconnect and interfacing electronically with respective memory controllers 354 and 356, for example, to read or write data from addresses in the memories 350 and 352. In an example, the first memory controller 354 (e.g., a DDR memory controller) and the second memory controller 356 (e.g., an HBM memory controller) utilize memory control components and techniques as are known in the field. In other examples, the first memory unit 350 and/or the second memory unit 352 are external to the EIC as described with reference to FIG. 1B. The memory units 350 and 352 can include any suitable memory type, including, for example, DDR and/or HBM. In one example, the first memory unit 350 is selected from memory types that generally allow for a large amount of data to be stored, whereas the second memory unit 352 is selected from memory types that generally allow for high speed. This can include, for example, using DDR as the type of memory for the first memory unit 350 and HBM as the type of memory for the second memory unit 352. In this manner, the fast memory (e.g., HBM) can act as a cache for the slower memory (e.g., DDR) and can enhance the performance of the memory module. Although the first and second memory units are shown as singular memory units, it should be understood that the first memory unit 350 may include multiple memory units, such as multiple separately packaged DDR units and the second memory unit 352 may include multiple memory units, such as multiple separately packaged HBM units.

In an example where the memory module 300 is a component of an AI accelerator or performing Deep Learning Recommendation Model (DLRM), it may be advantageous to store embedding tables in, for example, the first memory unit 350 (e.g., DDR) and extract tensors from the embedding table into the second memory unit 352 (e.g., HBM as cache memory) in advance of a read operation (e.g., a read request from a GPU) on the cache from a local or remote node. In an example, the tensors are a format specific to DLRM but various examples are not limited in the type of data structure that is used, whether it is a tensor, an array, a string, a series of bits etc. A datum is used herein to refer more generically to a tensor for DLRM, or to any other data structure, packet, or sequence of bits that can be used in a computer processing environment. To this end, a cache manager 362 of the EIC 302 can be configured to obtain a datum from the first memory unit 350 (e.g., a row from the embedding table or any other datum in a different application), optionally modify the datum, and write the datum to the second memory unit 352 (e.g., the cache). Once loaded, the cache can be used in an execution environment, such as a DLRM application, wherein the described cached datum (modified or unmodified) can be provided on a unidirectional photonic link 358 and/or 360, one end of which is associated with the memory module 300, for transmitting the datum in an optical form, either through the inter-chip photonic link 360 or the intra-chip photonic link 358. Similarly, a local or remote processor at the other end of the unidirectional photonic link can request to read a datum from the cache, in which case the read request is received via the photonic path 358 or 360 and transformed to electrical form in the photonic transceiver 320. In the case of photonic path 360, the remote link uses an external optical interface 312 (e.g., an FAU) between the photonic transceiver 320 and an optical waveguide (e.g., an optical fiber or optical fibers) that carry the optical signal to its destination or receive an optical signal from a source. The other end of these photonic paths 358 or 360 can be, for example, a local or remote processor or node that utilizes the datum in the cache. Various topologies are possible.

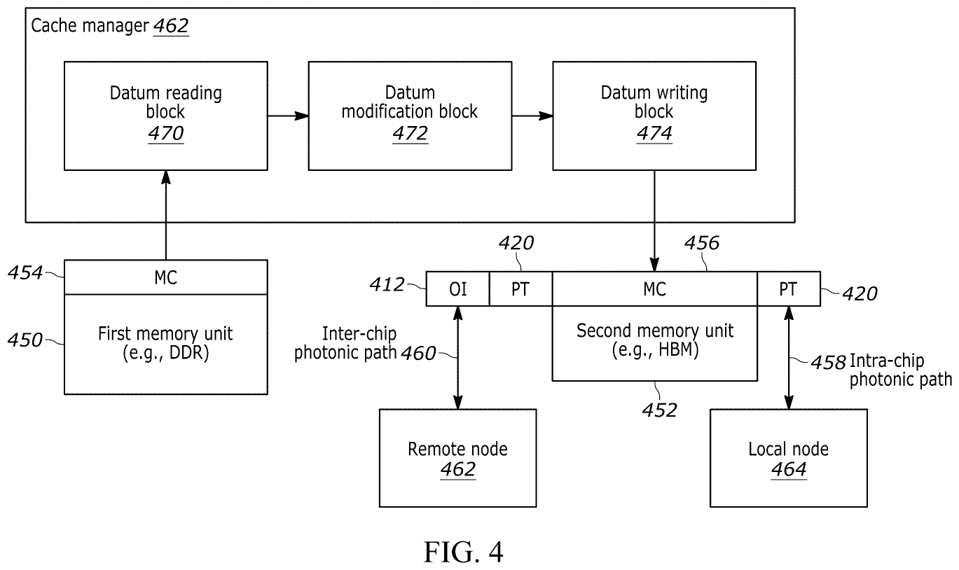

FIG. 4 is an expanded view of an example of a cache manager 462, which is similar to the cache manager 362 from FIG. 3, for the first memory 450 and the second memory unit 452 according to one example. The cache manager 462 is connected to the first memory unit 450 (e.g., DDR) through the memory controller 454 and to the second memory unit 452 (e.g., HBM) through the memory controller 456. The memory controller 456 of the second memory unit 452 (e.g., HBM) is in data communication with photonic transceivers 420. One photonic transceiver 420 is optically connected to an external optical interface 412 (e.g., an FAU), which is optically connected to a remote node 462 (e.g., a GPU) via an inter chip photonic path 460 (e.g., an optical fiber or optical fibers). The other photonic transceiver 420 is optically connected to a local node 464 (e.g., a local processor) via an intra chip photonic path 458 (e.g., via an optical waveguide within the PIC).

In the example of FIG. 4, the cache manager 462 includes a datum reading block 470, an optional datum modification block 472, and a datum writing block 474. The datum reading block 470 is configured to obtain a datum from the first memory unit 450 (e.g., a large capacity, relatively slow form of memory such as DDR) using the memory controller 454. In this way, the datum reading block 470 accesses an address in the first memory unit that stores a tensor, or other data structure, that is used by the application. In one example, this could include portions of embedding tables that are used for DLRM. In this application, the needs of the DLRM application may require that embedding tables consume a large amount of memory, in which case it is advantageous to save cost and use a slower, higher capacity memory such as DDR that is suitable for such large embedding tables. One skilled in the art will note that the current advantages apply equally well to a general-purpose computing process that might also require a massive amount of memory space to carry out its work.

When data is obtained from the first memory unit 450 (e.g., DDR), the datum modification block 472 may optionally make modifications to the datum or any addresses allocated to the datum, if optimizations are used by the application. This could include, for example, rotating the address portion of the datum, exchanging positions in the datum between a first and a second portion of the datum, rotating a bit portion of the datum from a rightmost position to a leftmost position and an address portion of the datum from a leftmost position to a rightmost position in the datum. Other types of modifications could be made to the datum. If modifications are used, the modified datum is written to the second memory unit 452 (e.g., HBM) by the datum writing block 474, otherwise, the unmodified data is written to the second memory unit 452 at the address space it was originally allocated, for example. Various caching schemes can be used including a direct mapped cache and a writing of the datum to a plurality of rows in the cache. Although the cache manager is shown with the optional datum modification block, the cache manager could be implemented without such a datum modification block.

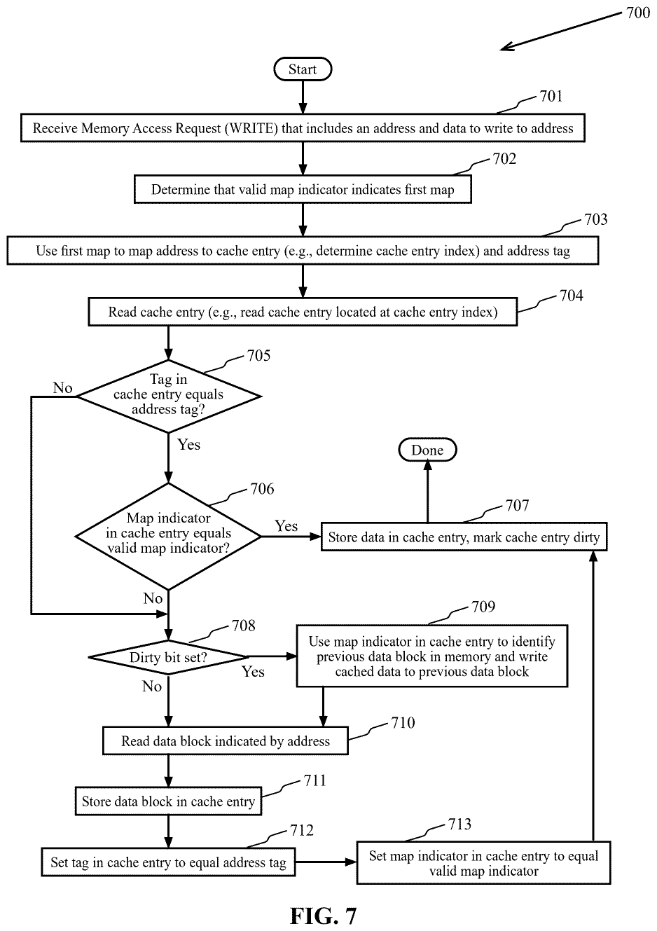

In an execution environment, a local or remote process may have a memory read operation scheduled with respect to a datum in a cache (e.g., see FIGS. 7, 1500) of the second type of memory such as second memory unit 452. In such a case, either the inter-chip photonic path 460 or the intra-chip photonic path 458 may be utilized, in which case, the transmit operation of the photonic transceiver 420 in the memory module will be to return the data along a corresponding unidirectional optical link in the opposite direction to the local or remote process.

In an example, the operations of the cache manager 462 are implemented in the EIC 402 in hardware, software, or a combination of hardware and software. For example, the EIC may be an ASIC that is configured to implement the cache manager 462, including the datum reading block 470, the datum modification block 472, and the datum writing block 474.

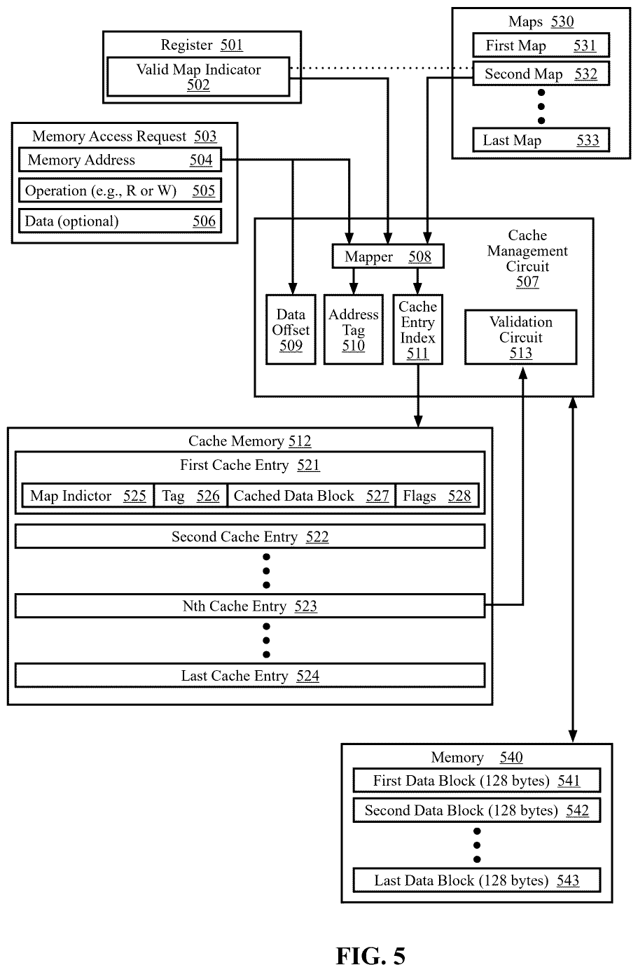

FIG. 5 is a high level conceptual diagram illustrating an example of a cache management circuit 507 configured to use a valid map indicator 502, according to some aspects. The cache management circuit 507 may implement the functionality of a cache manager such as the cache manager 362 shown in FIG. 3 or the cache manager 462 shown in FIG. 4. The cache management circuit may include a mapper 508 and a validation circuit 513. A register 501 may store a valid map indicator 502 that indicates one the available maps 530 such as a first map 531, a second map 532, a last map 533, etc. The cache management circuit 507 may include a mapper 508 configured to use the map indicated by the valid map indicator 502 to map an address to a cache entry in a cache memory 512. The cache memory 512 may include numerous cache entries such as a first cache entry 521, a second cache entry 522, an Nth cache entry 523 and a last cache entry 524. For example, a 32 GB HBM may include billions of cache entries. Each cache entry may include a map indicator 525, a tag 526, a cached data block 527, and flags 528. The map indicator 525 indicates which map was indicated by the valid map indicator when the cache entry was created. The cached data block 527 corresponds to a data block in a memory 540 that is being cached. Memory data is stored in memory 540. The memory 540 (e.g., DDR SDRAM) is divided into data blocks such as a first data block 541, a second data block 542, and the last data block 543. Each data block in the memory stores a specific amount of the memory data that is stored in the memory. For example, 128 byte data blocks store 128 bytes of memory data. The cached data blocks in the cache memory are the same size as the data blocks in memory. The least significant bits of an address may be used as a data offset 509 that specifies a location inside a data block. For example, the least significant 7 bits in an address may be a data offset that indicates a specific byte in a 128 byte data block. The mapper 508 may use the map to map the most significant bits of the address to an address tag 510 and a cache entry index 511. For example, the most significant 25 bits of a 32 bit address may be mapped to an address tag 510 and a cache entry index 511 while the 7 least significant bits are the data offset 509.

The cache management circuit may perform caching operations in response to receiving a memory access request. In general, a caching operation includes checking the cache to see if the data block indicated by the memory address is in the cache, using the cached data block if so, and otherwise optionally caching the data block indicated by the memory address.

In a direct caching example, a cache memory stores 32768 (2 to the 15th power) cache entries that are used to cache 128 byte data blocks (data offset is therefore 7 bits) from a memory that is accessed using 32 bit memory addresses. A memory access request 503 is received that includes a memory address 504 specifying a memory location, an opcode 505 indicating an operation to be performed (e.g., read from the memory location, write to the memory location, etc.), and may include data 506. One of the maps may use the most significant 15 bits of the 32 bit address as the cache entry index and the next 10 most significant bits as the address tag. As such, there may be 1024 data blocks with an address beginning with the same 15 most significant bits. The addresses of those 1024 data blocks are therefore mapped to the same cache entry index. As such, those 1024 blocks are all mapped to the same cache entry. The tag 526 in the cache entry may be used to identify which one of the 1024 data blocks is being cached by the cache entry. The validation circuit 513 may compare the address tag 510 to the tag 526 in the cache entry. If the address tag 510 does not equal the tag 526 then the cache entry is not caching the desired data block.

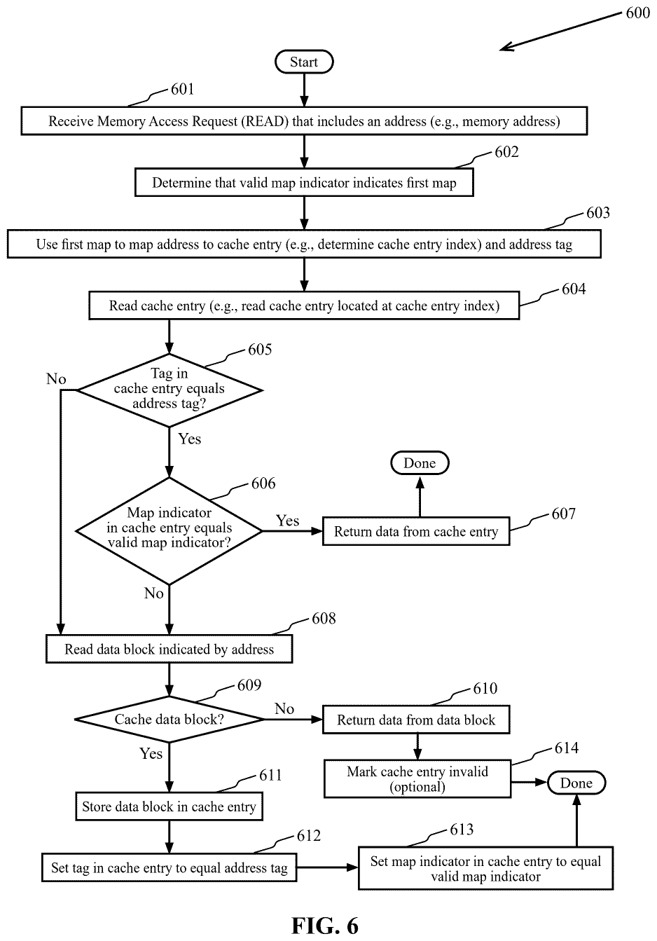

FIG. 6 is a high level flow diagram illustrating an example of a process 600 that uses a cache memory for reading data corresponding to a memory address, according to some aspects. The process 600 may be implemented by a cache manager (e.g., cache management circuit 507). The process 600 carries out caching operations related to reading data from a memory (e.g., memory 540) when data blocks of that memory may be cached by a cache memory (e.g., cache memory 512). At block 601, a memory access request 503 that includes an address 504 and an opcode indicating a read operation is received. The memory access request is a read request and therefore includes no data. The process is to return, in response to the memory access request, the memory data at the memory location indicated by the address 504. At block 602, the process determines that the valid map indicator indicates a first map. At block 603, the first map is used to map the address 504 to a cache entry (e.g., by determining the cache entry index) and address tag. At block 604, the cache entry is read. For example, the cache entry located at the cache entry index is read. At decision block 605, the tag 526 in the cache entry is compared to the address tag 510. The process moves to decision block 606 if the tag 526 in the cache entry equals the address tag 510 at decision block 605, otherwise the process moves to block 608. At decision block 606, the map indicator 525 in the cache entry is compared to the valid map indicator 502. The process moves to block 607 if the map indicator 525 in the cache entry equals the valid map indicator 502 at decision block 606, otherwise the process moves to block 608. Note that the validator may perform the comparisons at decision block 605 and decision block 606. At block 607, the requested data is returned from the cache entry. Here, the data offset may be used to determine which bytes in the cached data of the cache entry are the requested data. At block 608, the data block indicated by the address is read from memory. At decision block 609, the cache manager decides whether or not to cache the data block. There are numerous algorithms known in the art for making such a determination. In an example, the decision may be to always cache the data block. The process moves to block 611 if the data block is to be cached and otherwise moves to block 610. At block 610, the requested data is returned from the data block. Here, the data offset may be used to determine which bytes in the data block are the requested data. At block 614, the cache entry may be marked invalid. In an example, the map indicator is set to an “always invalid” value such as zero. In such an example, the valid map indicator is never set to zero, there is no 0th map, and the cache memory may be initialized by setting the map indicators in all the cache entries to 0. In another example, the flags in the cache entry include a valid bit that may be set to indicate that the cache entry is invalid. In another example, the cache entry is valid if the map indicator in the cache entry equals the valid map indicator and is otherwise invalid. As such, there may be no need for a valid bit. At block 611, the data block is stored in the cache entry. At block 612, the tag 526 in the cache entry is set to equal the address tag 510. At block 613, the map indicator 525 in the cache entry is set to equal the valid map indicator 502.

FIG. 7 is a high level flow diagram illustrating an example of a process 700 that uses a cache memory for writing data corresponding to a memory address, according to some aspects. The process 700 may be implemented by a cache manager (e.g., cache management circuit 507). The process 700 carries out caching operations relating writing data into a memory (e.g., memory 540) when data blocks of the memory may be cached by a cache memory (e.g., cache memory 512). At block 701, a memory access request 503 that includes an address 504, an opcode indicating a write operation, and data 506 is received. The memory access request is a write request and therefore includes write data (e.g., data 506) that is to be written to the memory at a memory location indicated by the address. At block 702, the process determines that the valid map indicator indicates a first map. At block 703, the first map is used to map the address 504 to a cache entry (e.g., by determining the cache entry index) and address tag. At block 704, the cache entry is read. For example, the cache entry located at the cache entry index is read. At decision block 705, the tag 526 in the cache entry is compared to the address tag 510. The process moves to decision block 706 if the tag 526 in the cache entry equals the address tag 510 at decision block 705, otherwise the process moves to decision block 708. At decision block 706, the map indicator 525 in the cache entry is compared to the valid map indicator 502. The process moves to block 707 if the map indicator 525 in the cache entry equals the valid map indicator 502 at decision block 706, otherwise the process moves to decision block 708. Note that the validator may perform the comparisons at decision block 705 and decision block 706. At block 707, the data 506 in the memory access request is stored in the cache entry and the cache entry is marked dirty. For example, the flags 528 in the cache entry may include a dirty flag. The cache entry may be marked dirty by setting a dirty flag in the cache entry (e.g., a dirty bit in flags 528). Setting a flag may include setting a flag that is already set (e.g., writing a 1 into the flag bit when the flag bit is already a 1). The dirty flag indicates that the cache entry is dirty and must be flushed to memory before the cache entry is used to cache a different memory block. Here, the data offset may be used to determine which bytes in the cached data of the cache entry are overwritten by the data 506 in the memory access request. At decision block 708, the dirty bit in the cache entry is checked. The process moves to block 709 if the dirty bit is set in the cache entry, otherwise the process moves to block 710. The cached data is flushed to memory at block 709. At block 709, the map indicated by the map indicator in the cache entry is used to identify previous data block in memory and then the cached data is written to the previous data block. Here, the cache entry is flushed to memory before the cache entry is overwritten by a newly read data block. At block 710, the data block indicated by the address is read from memory. At block 711, the data block is stored in the cache entry. At block 712, the tag 526 in the cache entry is set to equal the address tag 510. At block 713, the map indicator 525 in the cache entry is set to equal the valid map indicator 502. The process moves from block 713 to block 707. The process 700 may initialize the cache entry with the write data and the valid map indicator in response to determining that the map indicator in the cache entry does not equal the valid map indicator. Initializing the cache entry may include performing the operations of blocks 711, 712, and 713 and then performing the operations of block 707.

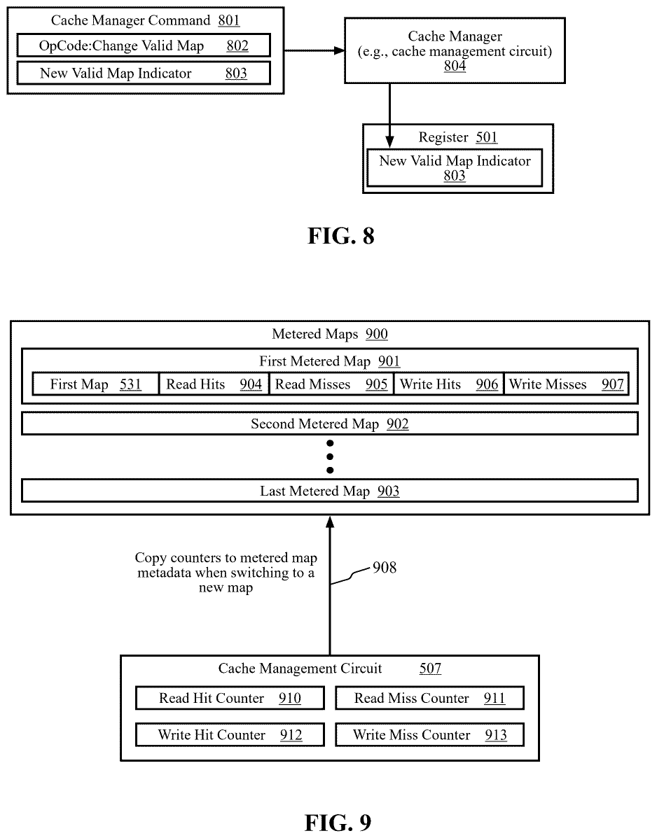

FIG. 8 is a high level conceptual diagram illustrating an example of a cache management circuit configured to change the valid map indicator to indicate a second map, according to some aspects. A cache manager 804 (e.g., cache management circuit 507) may receive a cache manager command 801 that includes an opcode 802 and a new valid map indicator 803. The opcode 802 directs the cache manager to change the valid map indicator 502 to the new valid map indicator 803. The cache manager 804, in response to the cache manager command 801, writes the new valid map indicator 803 into the register 501 that stores the valid map indicator 502.

FIG. 9 is a high level conceptual diagram illustrating an example of a cache management circuit configured to increment counters, according to some aspects. Here, the maps are implemented as metered maps 900 that include a first metered map 901, a second metered map 902, and a last metered map 903. The first metered map includes the first map and metered map metadata corresponding to the first map. The metered map metadata includes read hits 904, read misses 905, write hits 906, and write misses 907. The metered map metadata may be set from counters that track cache hits and misses as a map is used. In some examples, the metered map metadata may be stored in registers or memory (e.g., in HBM) that are separate from the maps. For example, the maps may be implemented as mapping circuits and the metered map metadata corresponding to each mapping circuit may be stored in registers reserved for the purpose.

The cache management circuit may include counters that store the metered map metadata for the currently valid map. A cache hit may occur during a read or write operation when the tag in the cache entry equals the address tag and the map indicator in the cache entry equals the valid map indicator. A cache read or write that is not a cache hit is a cache miss. The cache management circuit may include counters that are incremented when cache hits or cache misses occur. A read hit counter 910 may be incremented when a read operation has a cache hit. A read miss counter 911 may be incremented when a read operation has a cache miss. A write hit counter 912 may be incremented when a write operation has a cache hit. A write miss counter 913 may be incremented when a write operation has a cache miss. The read hit counter 910 and the write hit counter 912 are examples of cache hit counters. The read miss counter 911 and the write miss counter 913 are examples of cache miss counters. The cache hit/miss counters may be implemented, for example, as registers in the cache management circuit 507, as registers accessible by the cache management circuit 507, or as memory locations (e.g., as data in the HBM). The cache management circuit may copy 908 the cache hit/miss counters to the metered map metadata corresponding to the currently valid map when the valid map indicator is changed or written to.

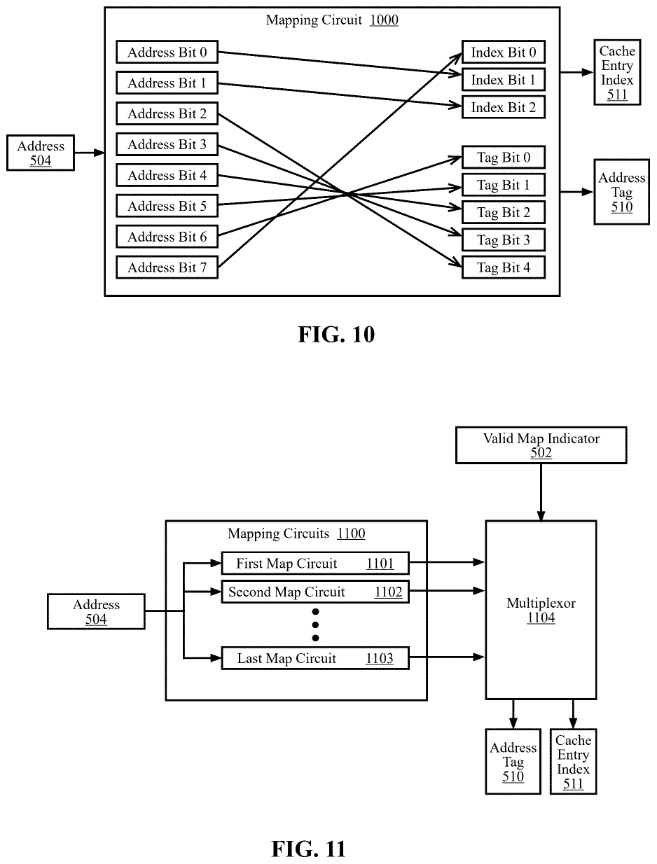

FIG. 10 is a high level conceptual diagram illustrating an example of a mapping circuit, according to some aspects. The mapping circuit 1000 may be implemented as map circuitry configured to produce a cache entry index 511 and an address tag 510 by reordering the bits of an address 504. The mapping circuit 1000 copies bits from the address 504 to bits in the address tag 510 and to bits in the cache entry index 511. Those practiced in digital circuitry know of a variety of circuits that reorder bits as needed by a mapping circuit such as mapping circuit 1000. In the example, address bit 0 is mapped to index bit 1, address bit 1 is mapped to index bit 2, address bit 2 is mapped to tag bit 4, address bit 3 is mapped to tag bit 3, address bit 4 is mapped to tag bit 2, address bit 5 is mapped to tag bit 1, address bit 6 is mapped to tag bit 0, and address bit 7 is mapped to index bit 0.

FIG. 11 is a high level conceptual diagram illustrating an example of a plurality of mapping circuits 1100, according to some aspects. The mapping circuits 1100 may be implemented as map circuitry (e.g., mapping circuit 1000) configured to produce a cache entry index 511 and an address tag 510 by reordering the bits of an address 504. An address 504 may be passed to map circuits 1100 that includes a first map circuit 1101, a second map circuit 1102, and a last map circuit 1103. Each of the map circuits may produce candidates that may be selected as the cache entry index and address tag. The valid map indicator 502 may be a control signal for a multiplexor 1104 that receives the outputs from the mapping circuits 1100 and selects the output corresponding to the map indicated by the valid map indicator. In an example, the valid map indicator 502 indicates the second map. As such, the multiplexor outputs the address tag and cache entry index produced by the second mapping circuit 1102. In an example, the multiplexor outputs the address tag and cache entry index produced by the second mapping circuit 1102 because the valid map indicator 502 indicates the second map. In another example, the multiplexor outputs the address tag and cache entry index produced by the last mapping circuit 1103 because the valid map indicator 502 indicates the last map.

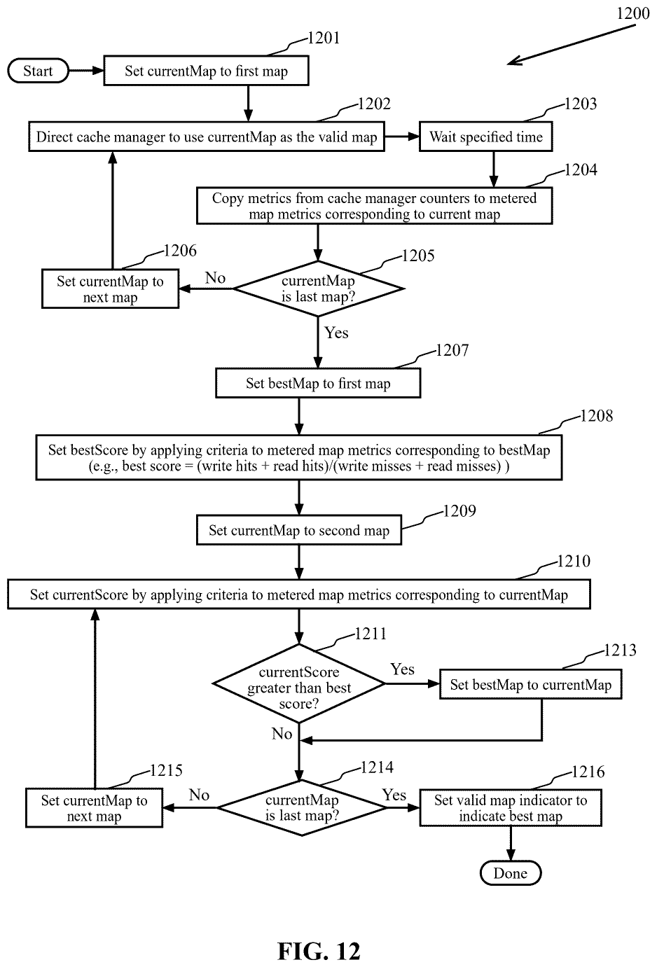

FIG. 12 is a high level flow diagram illustrating an example of a process 1200 that selects a bestMap, according to some aspects. This process automatically sets the valid map indicator to the currently best performing map. A map optimizer may perform the process 1200 in response to receiving an optimization command. An example of an optimization command is a cache manager command that includes an opcode that directs the cache manager to determine which map is currently best according to one or more criteria and to set the valid map indicator to indicate that map. In one example, a cache manager (e.g., cache management circuit 507) may function as a map optimizer. In another example, general purpose processing circuitry (e.g., x86, ARM, etc.) may be configured to implement a map optimizer by executing instructions. At block 1201, currentMap (a process variable) is set to the first map. At block 1202, the cache manager is directed to use currentMap as the valid map (see, e.g., FIG. 8). At block 1203, the process may wait for a specific amount of time to elapse. This gives the memory system time to collect metrics corresponding to currentMap. At block 1204, metrics (e.g., various cache hit and miss counts) are copied from cache manager counters to metered map metrics corresponding to currentMap. The process moves to block 1207 if currentMap is the last map at decision block 1205 and otherwise moves to block 1206. At block 1206, currentMap is set to the next map before the process loops back to block 1202. At block 1207, bestMap (a process variable) is set to indicate the first map. At block 1208, bestScore (a process variable) is set by applying criteria to metered map metrics corresponding to bestMap. The criteria used may be any of the many criteria that are known in the art. For example, bestScore may be set to a value calculated by the equation (write hits+read hits)/(write misses+read misses). As such, the criterion used is cache hits divided by cache misses. At block 1209, currentMap is set to the second map. At block 1210, currentScore is set by applying criteria to the metered map metrics corresponding to currentMap. At decision block 1211, the currentScore is compared to the bestScore. The process moves to block 1213 if the currentScore is greater than the bestScore and otherwise moves to block 1214. At block 1213, bestMap is set to currentMap. The process moves to block 1216 if currentMap is the last map and otherwise moves to block 1215. At block 1215, currentMap is set to the next map before the process loops back to block 1210. At block 1216, the valid map indicator is set to indicate bestMap before the process is done.

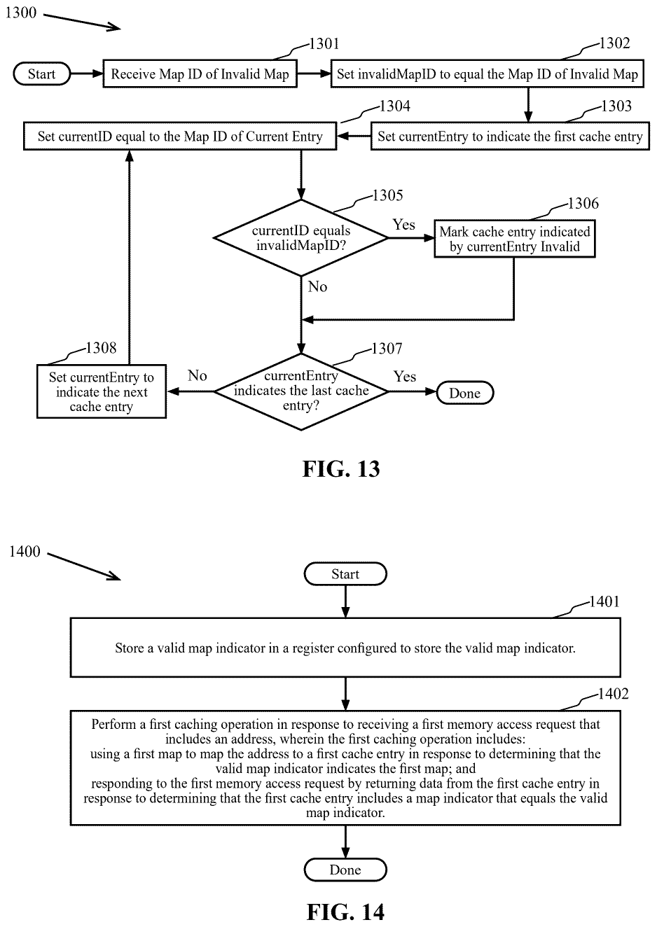

FIG. 13 is a high level flow diagram illustrating an example of a process 1300 that marks cache entries invalid, according to some aspects. The process 1300 may be run with lazy execution by the cache manager. Lazy execution is a term of art indicating that a process may be run at a low priority by a multitasking or multiprocessing system. In such systems, a low priority task may be preempted, suspended, or delayed such that higher priority tasks may be executed. In an example, the cache manager may be executing a process that marks cache entries invalid at a low priority. The cache manager may then suspend the process that marks cache entries invalid in order to execute a higher priority process such as one of the processes illustrated in FIG. 6 or 7. Regarding the illustrated process, the map ID of an invalid map may be received at block 1301. At block 1302, invalidMapID (a process variable) may be set to equal the map ID of the map that is being invalidated. A map may be invalidated when it is not to be used by the cache manager. For example, the cache manager may be using the second map, then switch to the third map. As such, the cache entries using the second map be marked invalid. At block 1303, currentEntry (a process variable) is set to indicate the first cache entry. At block 1304, currentID (a process variable) is set to equal the map ID stored in the cache entry indicated by currentEntry. At decision block 1305, currentID is compared to invalidMapID. The process moves to block 1306 if currentID equals invalidMapID and otherwise moves to decision block 1307. At block 1306, the cache entry indicated by currentEntry is marked invalid. In some examples, a cache entry may be marked invalid by setting an invalid bit/flag. In other examples, a map ID equaling zero, or some other predetermined value, indicates an invalid cache entry. At decision block 1307, currentEntry is checked to see if it indicates the last cache entry. The process is done if currentEntry indicates the last cache entry and otherwise moves to block 1308. At block 1308, current Entry is set to indicate the next cache entry.

FIG. 14 is a high level flow diagram illustrating an example of a method 1400 for cache management using multiple maps and a valid map indicator, according to some aspects. At block 1401, a valid map indicator is stored in a register configured to store the valid map indicator. At block 1402, a first caching operation is performed in response to receiving a first memory access request that includes an address, wherein the first caching operation includes using a first map to map the address to a first cache entry in response to determining that the valid map indicator indicates the first map, and responding to the first memory access request by returning data from the first cache entry in response to determining that the first cache entry includes a map indicator that equals the valid map indicator.

In an example, the memory module is embodied as a Co-Packaged Optics (CPO) device and/or as a System-in-Package (SiP) device. In such CPO and SiP devices, optical components (e.g., the PIC) and electrical components (e.g., the EIC) are packaged into a single device.

The terms “optical” and “photonic” are be used interchangeably herein to refer to electromagnetic signals and/or corresponding hardware that is designed to generate, manipulate, receive electromagnetic energy in wavelength ranges around 1,310 nm and 1,550 nm, although other wavelength ranges are possible.

Additional disclosure herein includes a method comprising obtaining a datum from a first type of memory in a memory package; writing the datum to a second type of memory in the memory package, receiving a read request for the datum across a first photonic link, a receive portion of the first photonic link being associated with the memory package, and transmitting the datum across a second photonic link, a transmit portion of the second photonic link being associated with the memory package. In an example, the method may further comprise modifying the datum. In an example, the datum has an address portion and a bit portion. In an example, the operation of modifying comprises rotating the bit portion. In an example, first type of memory includes one or more of NAND Flash memory, solid-state drive (SSD) memory, NOR Flash memory, conventional CMOS memory, thin film transistor-based memory, phase change memory (PCM), storage class memory (SCM) such as Optane, magneto-resistive memory (MRAM), resistive RAM (ReRAM or RRAM), and traditional DRAM (including HBM and DDR-based DRAM. In an example, the second type of memory includes one or more of NAND Flash memory, solid-state drive (SSD) memory, NOR Flash memory, conventional CMOS memory, thin film transistor-based memory, phase change memory (PCM), storage class memory (SCM) such as Optane, magneto-resistive memory (MRAM), resistive RAM (ReRAM or RRAM), and traditional DRAM (including HBM and DDR-based DRAM

Additional disclosure herein includes a memory appliance comprising one or more first memory units; one or more second memory units, a cache manager configured to obtain a datum from the first memory units and write the tensor to the second memory units, a first photonic link, one end of which has a receiver associated with the memory appliance, for receiving a request for the datum, and a second photonic link, one end of which has a transmitter associated with the memory appliance, for transmitting the modified datum. In an example, the first memory units include one or more of NAND Flash memory, solid-state drive (SSD) memory, NOR Flash memory, conventional CMOS memory, thin film transistor-based memory, phase change memory (PCM), storage class memory (SCM) such as Optane, magneto-resistive memory (MRAM), resistive RAM (ReRAM or RRAM), and traditional DRAM (including HBM and DDR-based DRAM. In an example, the second memory units include one or more of NAND Flash memory, solid-state drive (SSD) memory, NOR Flash memory, conventional CMOS memory, thin film transistor-based memory, phase change memory (PCM), storage class memory (SCM) such as Optane, magneto-resistive memory (MRAM), resistive RAM (ReRAM or RRAM), and traditional DRAM (including HBM and DDR-based DRAM. In an example, the cache manager is configured to rotate the datum.

The connections as discussed herein may be any type of connection suitable to transfer signals or power from or to the respective nodes, units, or devices, including via intermediate devices. The connections may be illustrated or described in reference to being a single connection, a plurality of connections, unidirectional connections, or bidirectional connections. However, different examples may vary the implementation of the connections. For example, single connections carrying multiple signals may be separated out into various different connections carrying subsets of these signals. The term “coupled” or similar language may include a direct physical connection or a connection through other intermediate components even when those intermediate components change the form of coupling from a source to a destination.

The present disclosure provides computing systems, implemented by one or more circuit packages (e.g., SIPs), that achieve reduced power consumption and/or increased processing speed. In accordance with various examples, power consumed for, in particular, data movement is reduced by maximizing data locality in a circuit package and reducing energy losses when data movement is needed. Power-efficient data movement, in turn, can be accomplished by moving data over small distances in the electronic domain, while leveraging photonic channels for data movement in scenarios where the resistance in the electronic domain and/or the speed at which the data can move in the electronic domain leads to bandwidth limitations that cannot be overcome using existing electronic technology. Thus, in some examples, each circuit package includes an electronic integrated circuit (EIC) that includes memory management components and photonic transceivers that are connected by bidirectional photonic channels (e.g., implemented in a PIC in a separate layer or chip of the package) into a hybrid, electronic-photonic (or electro-photonic) multiport network switch. The memory module may be connected, by bidirectional photonic channels, to other memory modules and/or network nodes (e.g., compute nodes and/or memory nodes).

As described herein, the present disclosure includes a number of practical applications having features described herein that provide benefits and/or solve problems associated with providing a memory module with sufficient storage capacity, data processing speed, and energy efficiency for effective operation in a data center, e.g., a data center that for processing AI and/or ML models. Some example benefits are discussed herein in connection with various features and functionalities provided by the computing system as described. It will be appreciated that benefits explicitly discussed in connection with one or more examples described herein are provided by way of example and are not intended to be an exhaustive list of all possible benefits of the computing system.

### Particular Implementations

Described implementations of the subject matter can include one or more features, alone or in combination, as described in the following clauses.
Clause 1. A system comprising a register configured to store a valid map indicator, a cache memory configured to store a plurality of cache entries, and a cache management circuit configured to perform a first caching operation in response to receiving a first memory access request that includes an address. The first caching operation includes using a first map to map the address to a first one of the cache entries in response to determining that the valid map indicator indicates the first map, and responding to the first memory access request by returning cached data from the first one of the cache entries in response to determining that the first one of the cache entries includes a map indicator that equals the valid map indicator.
Clause 2. The system of clause 1, wherein the first caching operation further includes incrementing a cache hit counter.
Clause 3. The system of clause 1 or clause 2, further including a mapping circuit configured to implement the first map.
Clause 4. The system of any of the clauses 1 to 3, wherein the cache management circuit is configured to change the valid map indicator to indicate a second map.
Clause 5. The system of clause 4, wherein the cache management circuit is further configured to perform a second caching operation in response to receiving a second memory access request that includes the address, wherein the second caching operation includes: using the second map to map the address to a second one of the cache entries in response to determining that the valid map indicator indicates the second map; reading memory data from a memory location indicated by the address in response to determining that the map indicator in the second one of the cache entries does not equal the valid map indicator; and responding to the second memory access request by returning the memory data read from the memory location indicated by the address.
Clause 6. The system of any of the clauses 1 to 4, wherein the cache management circuit is configured to perform a second caching operation in response to receiving a second memory access request that includes a second address indicating a second memory location, wherein the second caching operation includes: using the first map to map the second address to a second one of the cache entries in response to determining that the valid map indicator indicates the first map; reading memory data from the second memory location in response to determining that the map indicator in the second one of the cache entries does not equal the valid map indicator; and responding to the second memory access request by returning the memory data read from the second memory location.
Clause 7. The system of any of the clauses 1 to 6, wherein the second caching operation further includes storing the memory data read from the second memory location in the second one of the cache entries; and setting the map indicator in the second one of the cache entries to the valid map indicator.
Clause 8. The system of any of the clauses 1 to 6, wherein the second caching operation further includes setting a flag in the second one of the cache entries to indicate that the second one of the cache entries is invalid.
Clause 9. The system of any of the clauses 1 to 6, wherein the cache management circuit is configured to perform a second caching operation in response to receiving a write request that includes write data a second address indicating a second memory location at which to store the write data, wherein the second caching operation includes: using the first map to map the second address to a second one of the cache entries in response to determining that the valid map indicator indicates the first map; and initializing the second one of the cache entries with the write data and the valid map indicator in response to determining that the map indicator in the second one of the cache entries does not equal the valid map indicator.
Clause 10. The system of clause 9, wherein initializing the second one of the cache entries with the write data and the valid map indicator includes: writing the write data into the second one of the cache entries after reading memory data that includes the second memory location into the second one of the cache entries; and setting a flag to indicate the second one of the cache entries is dirty.
Clause 11. The system of any of the clauses 1-6 and 9, wherein the cache management circuit is configured to perform a second caching operation in response to receiving a write request that includes write data a second address indicating a second memory location at which to store the write data, wherein the second caching operation includes: using the first map to map the second address to a second one of the cache entries in response to determining that the valid map indicator indicates the first map; storing the write data in the second one of cache entries in response to determining that the map indicator in the second one of the cache entries equals the valid map indicator; and setting a flag indicating that the second one of the cache entries is dirty.
Clause 12. The system of any of the clauses 1 to 11, wherein the cache management circuit is configured to change the valid map indicator to indicate a second map in response to receiving a command to store a value in the register.
Clause 13. The system of any of the clauses 1 to 12, further including a map optimizer configured to: test a plurality of maps by changing the valid map indicator and storing a plurality of metrics corresponding to the maps; select one of the maps in response to applying one or more criteria to the metrics; and configure the cache management circuit to use the one of the maps.
Clause 14. A method comprising storing a valid map indicator in a register configured to store the valid map indicator; and performing a first caching operation in response to receiving a first memory access request that includes an address, wherein the first caching operation includes: using a first map to map the address to a first cache entry in response to determining that the valid map indicator indicates the first map; and responding to the first memory access request by returning cached data from the first cache entry in response to determining that the first cache entry includes a map indicator that equals the valid map indicator.
Clause 15. The method of clause 14, further including changing the valid map indicator to indicate a second map in response to receiving a command to store a value in the register.
Clause 16. The method of clause 14 or clause 15, wherein performing a second caching operation in response to receiving a second memory access request that includes the address, wherein the second caching operation includes: using the second map to map the address to a second cache entry in response to determining that the valid map indicator indicates the second map; reading memory data from a memory location indicated by the address in response to determining that the map indicator in the second cache entry does not equal the valid map indicator; and responding to the second memory access request by returning the memory data read from the memory location indicated by the address.
Clause 17. The method of any of the clauses 14 to 16, wherein a cache management circuit is configured to change the valid map indicator to indicate a second map in response to receiving a command to store a value in the register.
Clause 18. The method of any of the clauses 14 to 17, further including: testing a plurality of maps by changing the valid map indicator and storing a plurality of metrics corresponding to the maps in response to receiving an optimization command; selecting one of the maps in response to applying one or more criteria to the metrics; and configuring a cache management circuit to use the one of the maps.
Clause 19. A system comprising: a cache management circuit configured to perform a first caching operation in response to receiving a first memory access request that includes an address, wherein the first caching operation includes: using a first map to map the address to a first cache entry in response to determining that a valid map indicator indicates the first map; and responding to the first memory access request by returning cached data from the first cache entry in response to determining that the first cache entry includes a map indicator that equals the valid map indicator.
Clause 20. The system of clause 19, wherein the cache management circuit is further configured to change the valid map indicator such that the valid map indicator indicates a second map, and the cache management circuit is further configured to perform a second caching operation in response to receiving a second memory access request that includes the address, wherein the second caching operation includes: using the second map to map the address to a second cache entry in response to determining that the valid map indicator indicates the second map; reading memory data from a memory location indicated by the address in response to determining that the map indicator in the second cache entry does not equal the valid map indicator; and responding to the second memory access request by returning the memory data read from the memory location indicated by the address.

Although the operations of the method(s) herein are shown and described in a particular order, the order of the operations of each method may be altered so that certain operations may be performed in an inverse order or so that certain operations may be performed, at least in part, concurrently with other operations. In another example, instructions or sub-operations of distinct operations may be implemented in an intermittent and/or alternating manner.

It should also be noted that at least some of the operations for the methods described herein may be implemented using software instructions stored on a computer-usable storage medium for execution by a computer. As an example, an example of a computer program product includes a computer-usable storage medium to store a computer-readable program.

The computer-usable or computer-readable storage medium can be an electronic, magnetic, optical, electromagnetic, infrared, or semiconductor system (or apparatus or device). Examples of non-transitory computer-usable and computer-readable storage media include a semiconductor or solid state memory, magnetic tape, a removable computer diskette, a random access memory (RAM), a read-only memory (ROM), a rigid magnetic disk, and an optical disk. Current examples of optical disks include a compact disk with read-only memory (CD-ROM), a compact disk with read/write (CD-R/W), and a digital video disk (DVD).

Although specific examples have been described and illustrated, the claimed aspects are not to be limited to the specific forms or arrangements of parts so described and illustrated. The scope of the claims is to be defined by the claims appended hereto and their equivalents.

What is claimed is:

1. A system comprising:
a register configured to store a valid map indicator;
a cache memory configured to store a plurality of cache entries; and
a cache management circuit configured to perform a first caching operation in response to receiving a first memory access request that includes an address, wherein the first caching operation includes:
using a first map to map the address to a first one of the cache entries in response to determining that the valid map indicator indicates the first map; and
responding to the first memory access request by returning cached data from the first one of the cache entries in response to determining that the first one of the cache entries includes a map indicator that equals the valid map indicator.

2. The system of claim 1, wherein the first caching operation further includes incrementing a cache hit counter.

3. The system of claim 1, further including a mapping circuit configured to implement the first map.

4. The system of claim 1, wherein the cache management circuit is configured to change the valid map indicator to indicate a second map.

5. The system of claim 4, wherein:
the cache management circuit is further configured to perform a second caching operation in response to receiving a second memory access request that includes the address, wherein the second caching operation includes:
using the second map to map the address to a second one of the cache entries in response to determining that the valid map indicator indicates the second map;
reading memory data from a memory location indicated by the address in response to determining that the map indicator in the second one of the cache entries does not equal the valid map indicator; and
responding to the second memory access request by returning the memory data read from the memory location indicated by the address.

6. The system of claim 1, wherein:
the cache management circuit is configured to perform a second caching operation in response to receiving a second memory access request that includes a second address indicating a second memory location, wherein the second caching operation includes:
using the first map to map the second address to a second one of the cache entries in response to determining that the valid map indicator indicates the first map;
reading memory data from the second memory location in response to determining that the map indicator in the second one of the cache entries does not equal the valid map indicator; and
responding to the second memory access request by returning the memory data read from the second memory location.

7. The system of claim 6, wherein the second caching operation further includes:
storing the memory data read from the second memory location in the second one of the cache entries; and
setting the map indicator in the second one of the cache entries to the valid map indicator.

8. The system of claim 6, wherein the second caching operation further includes setting a flag in the second one of the cache entries to indicate that the second one of the cache entries is invalid.

9. The system of claim 1, wherein:
the cache management circuit is configured to perform a second caching operation in response to receiving a write request that includes write data a second address indicating a second memory location at which to store the write data, wherein the second caching operation includes:
using the first map to map the second address to a second one of the cache entries in response to determining that the valid map indicator indicates the first map; and
initializing the second one of the cache entries with the write data and the valid map indicator in response to determining that the map indicator in the second one of the cache entries does not equal the valid map indicator.

10. The system of claim 9, wherein initializing the second one of the cache entries with the write data and the valid map indicator includes:
writing the write data into the second one of the cache entries after reading memory data that includes the second memory location into the second one of the cache entries; and
setting a flag to indicate the second one of the cache entries is dirty.

11. The system of claim 1, wherein:
the cache management circuit is configured to perform a second caching operation in response to receiving a write request that includes write data a second address indicating a second memory location at which to store the write data, wherein the second caching operation includes:
using the first map to map the second address to a second one of the cache entries in response to determining that the valid map indicator indicates the first map;
storing the write data in the second one of cache entries in response to determining that the map indicator in the second one of the cache entries equals the valid map indicator; and
setting a flag indicating that the second one of the cache entries is dirty.

12. The system of claim 1, wherein the cache management circuit is configured to change the valid map indicator to indicate a second map in response to receiving a command to store a value in the register.

13. The system of claim 1, further including:
a map optimizer configured to:
test a plurality of maps by changing the valid map indicator and storing a plurality of metrics corresponding to the maps;
select one of the maps in response to applying one or more criteria to the metrics; and
configure the cache management circuit to use the one of the maps.

14. A method comprising:
storing a valid map indicator in a register configured to store the valid map indicator; and
performing a first caching operation in response to receiving a first memory access request that includes an address, wherein the first caching operation includes:
using a first map to map the address to a first cache entry in response to determining that the valid map indicator indicates the first map; and
responding to the first memory access request by returning cached data from the first cache entry in response to determining that the first cache entry includes a map indicator that equals the valid map indicator.

15. The method of claim 14, further including changing the valid map indicator to indicate a second map in response to receiving a command to store a value in the register.

16. The method of claim 15, wherein:
performing a second caching operation in response to receiving a second memory access request that includes the address, wherein the second caching operation includes:
using the second map to map the address to a second cache entry in response to determining that the valid map indicator indicates the second map;
reading memory data from a memory location indicated by the address in response to determining that the map indicator in the second cache entry does not equal the valid map indicator; and
responding to the second memory access request by returning the memory data read from the memory location indicated by the address.

17. The method of claim 14, wherein a cache management circuit is configured to change the valid map indicator to indicate a second map in response to receiving a command to store a value in the register.

18. The method of claim 14, further including:
testing a plurality of maps by changing the valid map indicator and storing a plurality of metrics corresponding to the maps in response to receiving an optimization command;
selecting one of the maps in response to applying one or more criteria to the metrics; and
configuring a cache management circuit to use the one of the maps.

19. A system comprising:
a cache management circuit configured to perform a first caching operation in response to receiving a first memory access request that includes an address, wherein the first caching operation includes:
using a first map to map the address to a first cache entry in response to determining that a valid map indicator indicates the first map; and
responding to the first memory access request by returning cached data from the first cache entry in response to determining that the first cache entry includes a map indicator that equals the valid map indicator.

20. The system of claim 19, wherein:
the cache management circuit is further configured to change the valid map indicator such that the valid map indicator indicates a second map; and
the cache management circuit is further configured to perform a second caching operation in response to receiving a second memory access request that includes the address, wherein the second caching operation includes:
using the second map to map the address to a second cache entry in response to determining that the valid map indicator indicates the second map;
reading memory data from a memory location indicated by the address in response to determining that the map indicator in the second cache entry does not equal the valid map indicator; and
responding to the second memory access request by returning the memory data read from the memory location indicated by the address.
